(19) United States
(12) Patent Application Publication
(10) Pub. No.: US 2012/0147725 A1
(43) Pub. Date: Jun. 14, 2012

(54) REPRODUCING APPARATUS AND REPRODUCING METHOD

(75) Inventors: Daisuke Ueda, Kanagawa (JP); Kimihiro Saito, Kanagawa (JP); Hirotaka Miyamoto, Kanagawa (JP)

(73) Assignee: SONY CORPORATION, Tokyo (JP)

(21) Appl. No.: 13/309,088

(22) Filed: Dec. 1, 2011

(30) Foreign Application Priority Data
Dec. 8, 2010 (JP) 2010-273796

(51) Int. Cl. G11B 7/1374; G11B 7/127

(52) U.S. Cl. 369/112.23; 369/121; G9B/7.103; G9B/7.121

(57) ABSTRACT

A reproducing apparatus includes: a first laser irradiation section irradiating an optical recording medium having a bulk recording layer and recording marks formed by focusing a laser beam on each predetermined layer position in the recording layer, with a first laser beam through an objective lens; a focus position adjusting section adjusting a focus position of the first laser beam; a beam receiving section receiving a reflected beam of the first laser beam from the marks and generating a light receiving signal; a reproducing section reproducing information recorded with the marks based on the light receiving signal; and a control section performing control to allow the focus position in reproduction of the information to correspond to a position shifted by a certain distance to an upper layer side from a focus position of the laser beam in forming the mark at the layer positions as a reproducing object.

### BACKGROUND

The present disclosure relates to a reproducing apparatus and a reproducing method to reproduce an optical recording medium.

A so-called optical disc such as CD (Compact Disc), DVD (Digital Versatile Disc), or BD (Blu-ray Disc: registered trademark) is widely used as an optical recording medium to perform recording/reproduction of a signal using light irradiation.

As the next-generation optical recording medium following the current medium such as CD, DVD, and BD, the applicant has previously proposed a so-called bulk-recording optical recording medium as disclosed in Japanese Unexamined Patent Application Publication No. 2008-135144 (JP-A-2008-135144) and Japanese Unexamined Patent Application Publication No. 2008-176902 (JP-A-2008-176902).

The bulk recording means the technology to achieve large recording capacity by applying a laser beam to an optical recording medium (bulk-type recording medium 100) having a cover layer 101 and a bulk layer (recording layer) 102 while a focus position is successively changed and thus allowing multilayer recording in the bulk layer 102, for example, as illustrated in FIG. 6.

As for such bulk recording, JP-A-2008-135144 discloses a recording technique, so-called micro-hologram method. In the micro-hologram method, a so-called hologram recording material is used as a recording material of the bulk layer 102. For example, a photopolymerization-type photopolymer is widely known as the hologram recording material.

The micro-hologram method is roughly classified into two methods, a positive-type micro-hologram method and a negative-type micro-hologram method. The positive-type micro-hologram method is a technique where two opposed beams (beam A and beam B) are condensed at the same position to form a fine interference fringe (hologram) to be used as a recording mark.

Conversely, the negative-type micro-hologram method is a technique where an interference fringe is beforehand formed and partially erased by laser beam irradiation, and the erased part is used as a recording mark. In the negative-type micro-hologram method, initialization processing is performed to the bulk layer 102 before recording operation in order to form the interference fringe. Specifically, in the initialization processing, the bulk layer is irradiated with parallel beams, thereby an interference fringe is formed in the entire bulk layer 102. The interference fringe is beforehand formed by the initialization processing in this way, and then information recording is performed through formation of erased marks. That is, while an optional layer position is focused, laser beam irradiation is performed in correspondence to information to be recorded, so that information recording is performed using the erased marks.

A bulk recording technique other than the micro-hologram method includes, for example, a recording technique using voids formed as recording marks as disclosed in JP-A-2008-176902. The reproducing method according to an embodiment of the disclosure uses an optical recording medium having voids formed as recording marks. The void recording method is a technique where a laser beam is applied at a relatively high power to a bulk layer 102 configured of, for example, a recording material such as a photopolymerization-type photopolymer so that voids are formed in the bulk layer 102. As disclosed in JP-A-2008-176902, each of the void portions formed in such a way is different in refractive index from another portion in the bulk layer 102, resulting in increase in reflectance at a boundary of the void. Accordingly, the void portion functions as a recording mark, and consequently information recording is achieved through formation of void marks.

In such a void recording method, hologram is not formed, and therefore a beam may be applied only from one side for recording. That is, two beams to be condensed at the same position for forming recording marks are not necessary unlike the positive-type micro-hologram method. In addition, initialization processing is advantageously unnecessary unlike the negative-type micro-hologram method. It is to be noted that while JP-A-2008-176902 discloses an example where pre-cure light irradiation is performed before performing void recording, void recording may be performed without such pre-cure light irradiation.

While various recording techniques have been proposed for the bulk-recording-type (or simply called bulk-type) optical disc recording medium as above, a recording layer (bulk layer) of the bulk-type optical disc recording medium does not include an explicit multilayer structure, for example, a plurality of reflection films. That is, the bulk layer 102 is not provided with a reflection film and a guide groove for each of the recording layers unlike a typical multilayer disc. Consequently, when the bulk-type recording medium 100 has a structure as illustrated in FIG. 6, focusing servo and tracking servo are hardly performed in recording since marks are not formed yet.

Thus, the bulk-type recording medium 100 is actually provided with a reflective surface as a reference (reference surface) having a guide groove as illustrated in FIG. 7. Specifically, a guide groove (position guider) including, for example, pits or a groove is formed spirally or concentrically on a bottom surface side of a cover layer 101, and a selective reflection film 103 is formed thereon. In addition, a bulk layer 102 is laminated on the lower layer side of the cover layer 101, on which the selective reflection film 103 is formed in the above way, with an adhesive material, for example, UV-curable resin, as an intermediate layer 104 shown in FIG. 7. Absolute positional information (address information) such as radial positional information and rotational angle information is recorded through formation of the guide groove including pits or a groove as described above. In the following description, a surface, on which such a guide groove is formed and thus the absolute positional information is recorded, (in this case, a surface having the selective reflection film 103 thereon) is called a “reference surface Ref”. It is to be noted that while FIG. 7 exemplifies a structure where the intermediate layer 104 is provided between the bulk layer 102 and the selective reflection film 103, the intermediate layer 104 may not be provided. For example, when a recording material of the bulk layer 102 is a thermosetting or photocurable resin, the resin material is applied on a bottom surface side of the selective reflection film 103 and then cured, thereby the bulk layer 102 may be formed on the bottom surface side of the reflection film 103 without forming the intermediate layer 104.

After the above medium structure is formed, the bulk-type recording medium 100 is irradiated with a servo laser beam (or simply called a servo beam) as a laser beam for position control separately from a laser beam for recording (or reproducing) marks (hereinafter, called recording/reproducing laser beam or simply called recording/reproducing beam), as illustrated in FIG. 8. As illustrated in FIG. 8, the bulk-type recording medium 100 is irradiated with the recording/reproducing laser beam and the servo laser beam through a common objective lens.

Here, if the servo laser beam arrives at the bulk layer 102, mark recording in the bulk layer 102 may be adversely affected. Thus, in the bulk recording method, a laser beam having a different wavelength range from the recording/reproducing laser beam is used as the servo laser beam, and the selective reflection film 103 having a wavelength selectivity of reflecting the servo laser beam but transmitting the recording/reproducing laser beam is provided as a reflection film formed on the reference surface Ref.

On the basis of the above, description is made on operation applied to the bulk-type recording medium 100 during mark recording, with reference to FIG. 8. First, when multilayer recording is performed in the bulk layer 102 having no guide groove and no reflection film, layer positions in the bulk layer 102 in a depth direction are beforehand determined to form marks. FIG. 8 exemplifies a case where five information recording layer positions L in total, a first information recording layer position L1 to a fifth information recording layer position L5, are set as the layer positions (or called mark formation layer positions or information recording layer positions) for forming marks in the bulk layer 102. As illustrated in FIG. 8, the first information recording layer position L1 is set as a position away from the selective reflection film 103 (reference surface Ref) having the guide groove thereon by first offset of-L1 in a focus direction (depth direction). The second information recording layer position L2, the third information recording layer position L3, the fourth information recording layer position L4, and the fifth information recording layer position L5 are set as positions away from the reference surface Ref by second offset of-L2, third offset of-L3, fourth offset of-L4, and fifth offset of-L5, respectively.

In recording, an objective lens performs focusing servo control and tracking servo control such that a spot position of the servo laser beam follows the guide groove on the reference surface Ref based on a reflected beam of the servo laser beam.

The recording/reproducing laser beam needs to arrive at the bulk layer 102 formed on a lower layer side from the reference surface Ref for mark recording. The optical system is therefore provided with a recording/reproducing beam focusing mechanism separately from a focusing mechanism of the object lens in order to independently adjust a focus position of the recording/reproducing laser beam.

FIG. 9 illustrates an outline of an optical system for recording/reproduction of the bulk-type recording medium 100 including such a mechanism to independently adjust the focus position of the recording/reproducing laser beam. As illustrated in FIG. 9, the objective lens may be displaced by a biaxial actuator in a radial direction (tracking direction) of the bulk-type recording medium 100 and in a vertical direction (focusing direction) to the bulk-type recording medium 100.

In FIG. 9, a focusing mechanism (expander) corresponds to the mechanism to independently adjust the focus position of the recording/reproducing laser beam. Specifically, the focusing mechanism as the expander includes a fixed lens and a movable lens held by a lens drive section in a displaceable manner in a direction parallel to an optical axis of the recording/reproducing laser beam. The movable lens is moved by the lens drive section, causing change in collimation state (convergence, parallelism, or radiation) of the recording/reproducing laser beam incident to the objective lens shown in FIG. 9, so that the focus position of the recording/reproducing laser beam is adjusted independently of the servo laser beam.

Since the recording/reproducing laser beam is different in wavelength range from the servo laser beam as described above, the optical system is correspondingly designed such that a reflected beam of the recording/reproducing laser beam from the bulk-type recording medium 100 and a reflected beam of the servo laser beam therefrom are separated into respective systems by a dichroic prism shown in FIG. 9, namely, such that each reflected beam may be independently detected. As for a going beam, the dichroic prism functions to compose the recording/reproducing laser beam and the servo laser beam to be coaxial with each other and then inputs the composed beams to the objective lens. Specifically, in this case, after the recording/reproducing laser beam is output from the expander, the laser beam is reflected by a mirror, and then reflected by the selective reflection surface of the dichroic prism, and then input to the objective lens, as illustrated in FIG. 9. In contrast, the servo laser beam is transmitted by the selective reflection surface of the dichroic prism and then input to the objective lens.

In such a configuration, focus control of the recording/reproducing laser beam in recording is specifically performed as follows. First, focus control of the objective lens is performed in such a manner that a position of the objective lens in a focusing direction is controlled based on a reflected beam of the servo laser beam from the reference surface Ref such that a focus position of the servo laser beam corresponds to the reference surface Ref. Then, while the position of the objective lens is controlled such that the focus position of the servo laser beam corresponds to the reference surface Ref in this way, the lens drive section in the expander as shown in FIG. 9 is moved depending on a value of the offset of-L set in correspondence to an information recording layer position L as a recording object. This makes it possible to adjust the focus position of the recording/reproducing laser beam to correspond to the information recording layer position L as a recording object, and consequently mark recording may be performed at the information recording layer position L as a recording object.

In addition, focus control in reproduction is performed using the same technique as in recording.

Tracking control is performed through position control of the objective lens. That is, tracking control of the recording/reproducing laser beam in recording is automatically performed by controlling a position of the objective lens such that a spot position of the servo laser beam follows the guide groove on the reference surface Ref based on the reflected beam of the servo laser beam.

### SUMMARY

While the bulk recording method includes the void recording method using marks formed of voids as described before, it has been known that when the void recording method is used, SNR (Signal-to-Noise Ratio) tends to be reduced in reproduction due to the following phenomenon.

FIG. 10 explains a cause of reduction in SNR in the void recording method. Since the void recording method is a technique where a void is formed as a recording mark, the recording mark (void mark) M is formed with certain broadening about a focus position Fr in recording as illustrated in FIG. 10.

In the recording/reproducing device in the past, the same technique is used for focus control in each of recording and reproduction as described before. Accordingly, focus control is performed such that a focus position Fr of the recording/reproducing laser beam in recording corresponds to a focus position Fp thereof in recording as illustrated in FIG. 10.

This causes defocus of the recording/reproducing laser beam in reproduction as shown by ΔF in FIG. 10. Such defocus ΔF causes reduction in SNR of the reproduction signal in the void recording method.

Measures may be taken against the reduction in SNR, for example, increase in reproducing power of a laser beam or choice of a sensitive article as a light receiving section may be performed. However, increase in reproducing power may lead to damage to a recording material for the bulk layer 102, increase in power consumption of a system, and reduction in laser life. In addition, when the sensitive article is used for the light receiving section, reduction in transfer rate may occur due to reduction in bandwidth of a reproduction signal, or increase in development/production cost may occur due to use of a special device as the sensitive article.

It is desirable to provide a reproducing apparatus and a reproducing method, each making it possible to suppress reduction in SNR of a reproduction signal, in the case that a recording method using recording marks, each being formed three-dimensionally with certain broadening, such as the void recording method is used as a bulk recording method.

Thus, a reproducing apparatus according to an embodiment of the disclosure is configured as follows. That is, the reproducing apparatus includes a first laser irradiation section irradiating an optical recording medium having a bulk recording layer with a first laser beam through an objective lens, the optical recording medium having recording marks formed by focusing a laser beam on each predetermined layer position in the recording layer. In addition, the reproducing apparatus includes a focus position adjusting section adjusting a focus position of the first laser beam. In addition, the reproducing apparatus includes a beam receiving section receiving a reflected beam of the first laser beam from each of the marks formed in the optical recording medium and generating a light receiving signal, and a reproducing section reproducing information recorded with each of the marks based on the light receiving signal from the beam receiving section. In addition, the reproducing apparatus includes a control section performing control to allow the focus position of the first laser beam in reproduction of the information recorded with each of the marks to correspond to a position shifted by a certain distance to an upper layer side from a focus position of the laser beam in forming the mark at each of the layer positions as a reproducing object.

In addition, a reproducing apparatus according to another embodiment of the disclosure is configured as follows. That is, the reproducing apparatus includes a first laser irradiation section irradiating an optical recording medium having a bulk recording layer with a first laser beam through an objective lens, the optical recording medium having recording marks formed by focusing a laser beam on respective predetermined layer positions in the recording layer. In addition, the reproducing apparatus includes a focus position adjusting section adjusting a focus position of the first laser beam. In addition, the reproducing apparatus includes a beam receiving section receiving a reflected beam of the first laser beam from each of the marks formed in the optical recording medium, and generating a light receiving signal, and a reproducing section reproducing information recorded with each of the marks based on the light receiving signal from the beam receiving section. Furthermore, the reproducing apparatus includes a control section controlling the focus position adjusting section to allow the focus position of the first laser beam in reproduction of the information recorded with each of the marks to correspond to a top surface portion of the mark formed at each of the layer positions as a reproducing object.

According to the embodiments of the disclosure, the focus position of the first laser beam in reproduction may be adjusted to the position shifted by a certain distance to the upper layer side from the focus position of the laser beam in forming the mark at each of the layer positions as a reproducing object. This makes it possible to suppress defocus ΔF, which has occurred in reproduction when the void recording method is used among the bulk recording methods. As a result, reduction in SNR of a reproduction signal may be effectively suppressed.

According to the embodiments of the disclosure, defocus, which has occurred in reproduction when the void recording method is used among the bulk recording methods, may be suppressed, and therefore SNR of the reproduction signal may be improved. Accordingly, measures to improve SNR, such as increase in reproducing power of a laser beam or choice of a sensitive article as a beam receiving section, need not be taken, resulting in reduction in damage to a recording material, reduction in power consumption of a system, long laser life, improvement in transfer rate, and reduction in development/production cost. In addition, since SNR is improved, recording density may be increased, leading to large recording capacity of the optical recording medium. Moreover, since damage to the recording material is reduced, preservation stability of recorded information may be improved. Moreover, the SNR improvement technique according to the embodiments of the disclosure is extremely simple: the focus position is shifted by a certain distance. In this respect, the technique contributes to simplification of algorithmic development and of IC development.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a structural cross-sectional view of an optical recording medium as a reproducing object in an embodiment of the disclosure.

FIG. 2 is a block diagram illustrating a configuration of an optical system in a reproducing apparatus as an embodiment.

FIG. 3 is a block diagram illustrating an internal configuration of the reproducing apparatus as a whole as an embodiment.

FIG. 4 illustrates a focus control technique in reproduction.

FIGS. 5A and 5B illustrate an experimental result of a relationship between the amount of offset from a focus position in recording and a signal level.

FIG. 6 illustrates a bulk recording method.

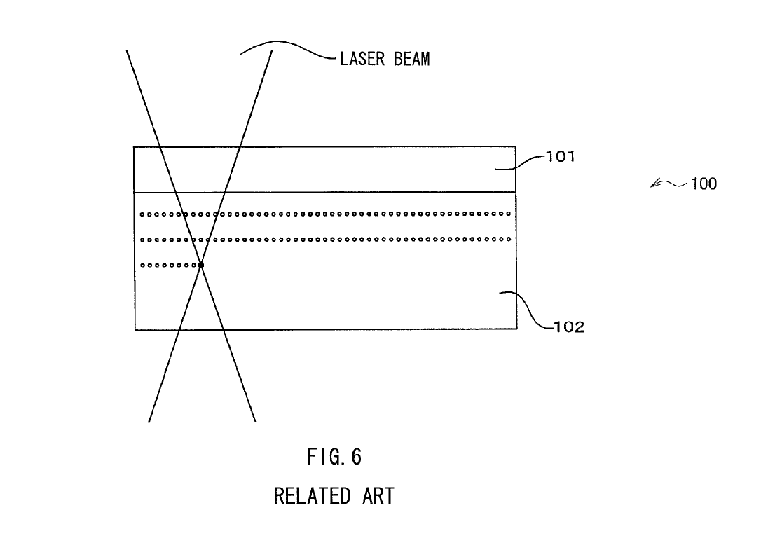

FIG. 7 illustrates a sectional structure of an actual bulk-type recording medium having a reference surface.

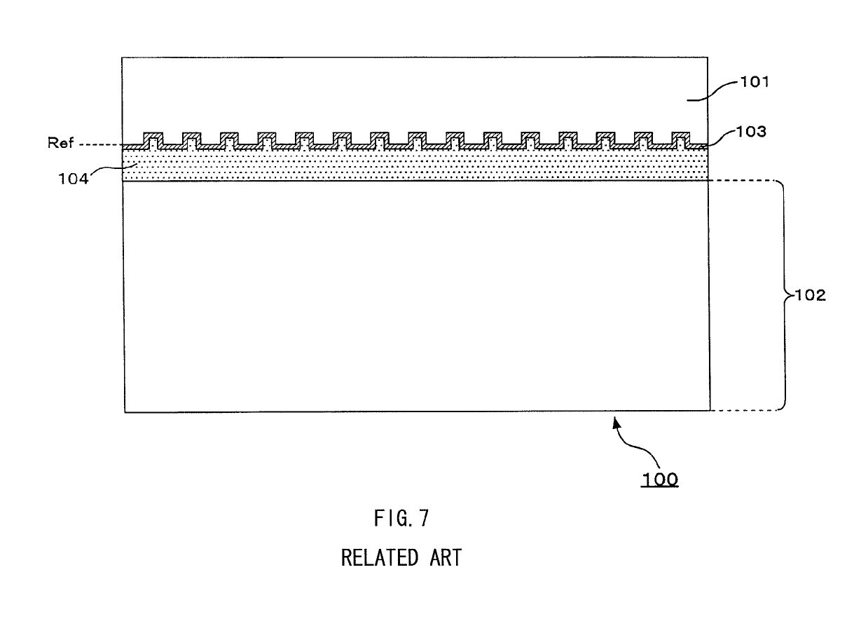

FIG. 8 illustrates operation in mark recording in the bulk-type recording medium.

FIG. 9 illustrates an outline of an optical system for recording/reproduction of the bulk-type recording medium.

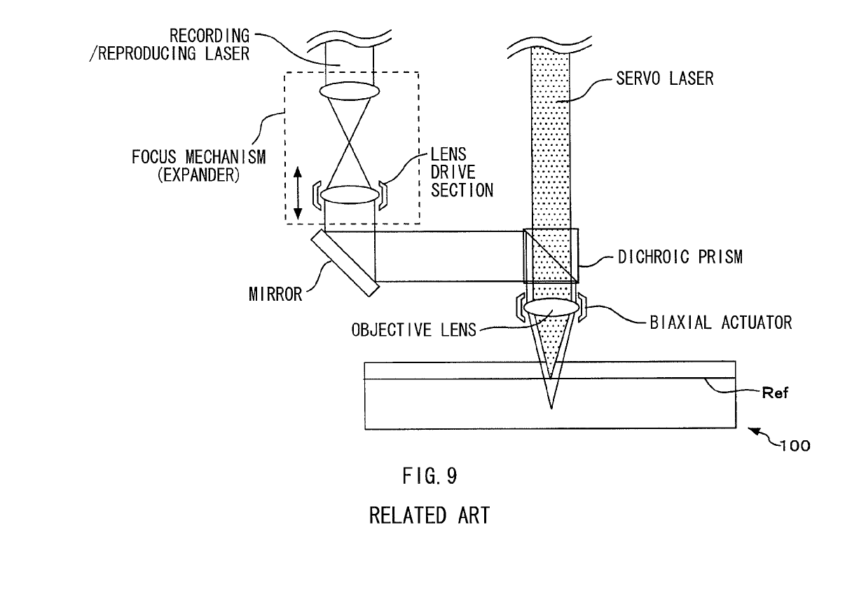

FIG. 10 illustrates a cause of reduction in SNR in the void recording method.

### DETAILED DESCRIPTION OF EMBODIMENTS

Hereinafter, an embodiment of the disclosure will be described.

Description is made in the following order.

1. Optical recording medium as recording/reproducing object

2. Configuration of reproducing apparatus

3. Focus control technique in reproduction

4. Experimental result

5. Modifications

### [1. Optical Recording Medium as Recording/Reproducing Object]

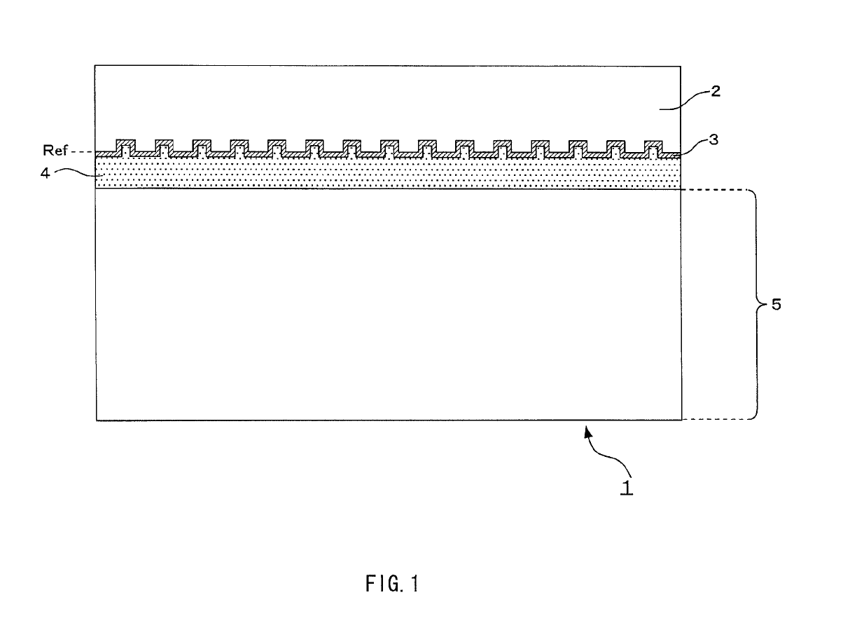

FIG. 1 illustrates a structural, cross-sectional view of an optical recording medium as a recording/reproducing object in the embodiment. The optical recording medium as a recording/reproducing object in the embodiment is a so-called bulk-recording-type optical recording medium, and called bulk-type recording medium 1 below. The bulk-type recording medium 1 is a disc-shaped optical recording medium, and a laser beam is applied to the bulk-type recording medium 1 being rotated so that mark recording (information recording) is performed. Similarly, a laser beam is applied to the bulk-type recording medium 1 being rotated for reproducing recorded information. It is to be noted that the optical recording medium is a general term of recording media using light irradiation for recording/reproduction of information.

The bulk-type recording medium 1 has a cover layer 2, a selective reflection film 3, an intermediate layer 4, and a bulk layer 5 in this order from an upper layer side as illustrated in FIG. 1. The “upper layer side” described herein refers to an upper layer side when a surface of the medium 1, to which a laser beam is incident from a reproducing apparatus (recording/reproducing apparatus 10) as an embodiment described later, is assumed as a top surface.

Moreover, the “depth direction” herein refers to a direction corresponding to a vertical direction in accordance with the definition of the “upper layer side”, namely, a direction (focusing direction) parallel to an incident direction of the laser beam from the reproducing apparatus.

In the bulk-type recording medium 1, the cover layer 2 is configured of resin such as polycarbonate and acrylic, and a guide groove is formed on a bottom surface side of the cover layer as a position guider to guide the laser beam to a recording/reproducing position, so that an irregular section profile is provided as illustrated in FIG. 1. The guide groove is formed of a continuous groove or a pit string. For example, when the guide groove is formed of a pit string, positional information (absolute positional information, for example, rotational angle information or radial positional information) is recorded using a combination of pit length and land length. Alternatively, when the guide groove is formed of a groove, the groove is periodically wobbled, thereby positional information is recorded using periodical information of the wobbled groove. The cover layer 2 is produced, for example, by injection molding using a stamper having such a guide groove (irregular shape).

In addition, the selective reflection film 3 is formed on the bottom surface side, having the guide groove, of the cover layer 2. As described before, in the bulk recording method, the medium is irradiated with a beam (servo laser beam, or simply called servo beam) for acquiring an error signal of tracking and focusing based on the guide groove (position guider) separately from the beam (recording/reproducing laser beam, or simply called recording/reproducing beam) for recording/reproducing the mark in the bulk layer 5 as a recording layer. At this time, if the servo laser beam arrives at the bulk layer 5, mark recording in the bulk layer 5 may be adversely affected. This leads to a need of a reflection film having a selectivity of reflecting the servo laser beam but transmitting the recording/reproducing laser beam. In the bulk recording method, the recording/reproducing laser beam has been different in wavelength range from the servo laser beam, and a film, having a wavelength selectivity of reflecting a beam in the same wavelength range as the servo laser beam but transmitting a beam having another wavelength, has been correspondingly used as the selective reflection film 3.

The bulk layer 5 as the recording layer is formed or adhered on a lower layer side of the selective reflection film 3 through the intermediate layer 4 configured of an adhesive material such as a UV curable resin. As a formation material (recording material) of the bulk layer 5, an optimum material can be appropriately used depending on a bulk recording method to be used, for example, the positive-type micro-hologram method, the negative-type micro-hologram method, and the void recording method as described before. In the embodiment, the void recording method is used as a mark recording method for the optical recording medium. In the case of the void recording method, for example, resin may be listed as the formation material of the bulk layer 5.

In the bulk-type recording medium 1 having the above sectional structure, the selective reflection film 3 having the position guider acts as a reflective surface as a reference for position control of the recording/reproducing laser beam based on the servo laser beam, as described later. In this sense, the surface having the selective reflection film 3 thereon is called reference surface Ref below.

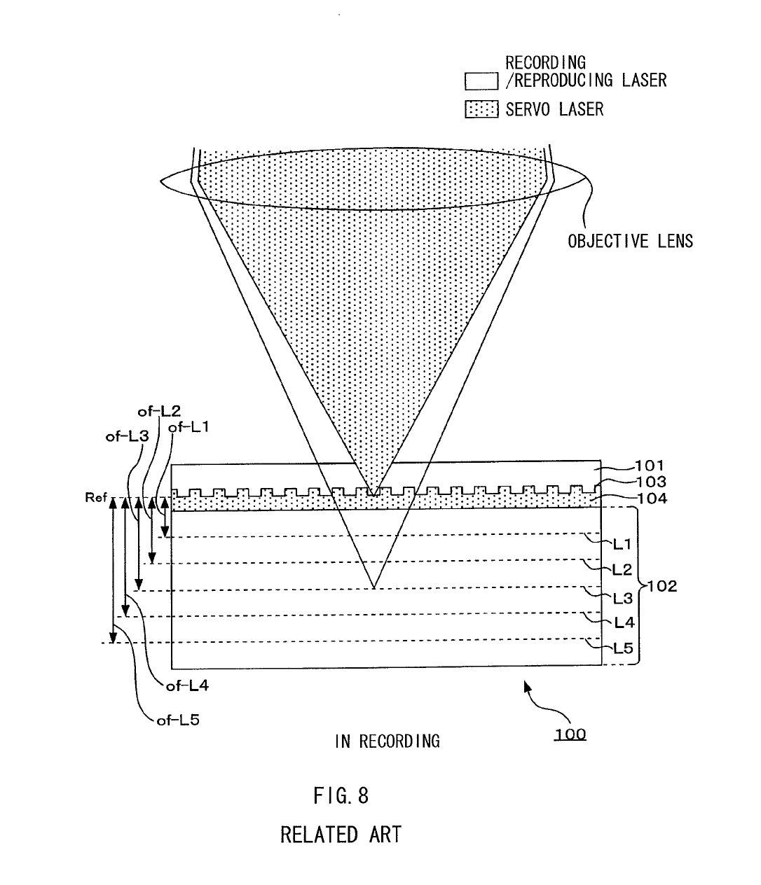

In the bulk-type optical recording medium, each of layer positions (information recording layer positions L), at which information recording is to be performed, is beforehand set for multilayer recording in the bulk layer, as described with FIG. 8. In the bulk-type recording medium 1, for the information recording layer positions L, a first information recording layer position L1, a second information recording layer position L2, a third information recording layer position L3, a fourth information recording layer position L4, and a fifth information recording layer position L5 are set away from the reference surface Ref in the depth direction by first offset of-L1, second offset of-L2, third offset of-L3, fourth offset of-L4, and fifth offset of-L5, respectively, as in the case shown in FIG. 8. Information of the offset of-L from the reference surface Ref to each of the layer positions L is set in a controller 40 in the recording/reproducing apparatus 10 described later.

### [2. Configuration of Reproducing Apparatus]

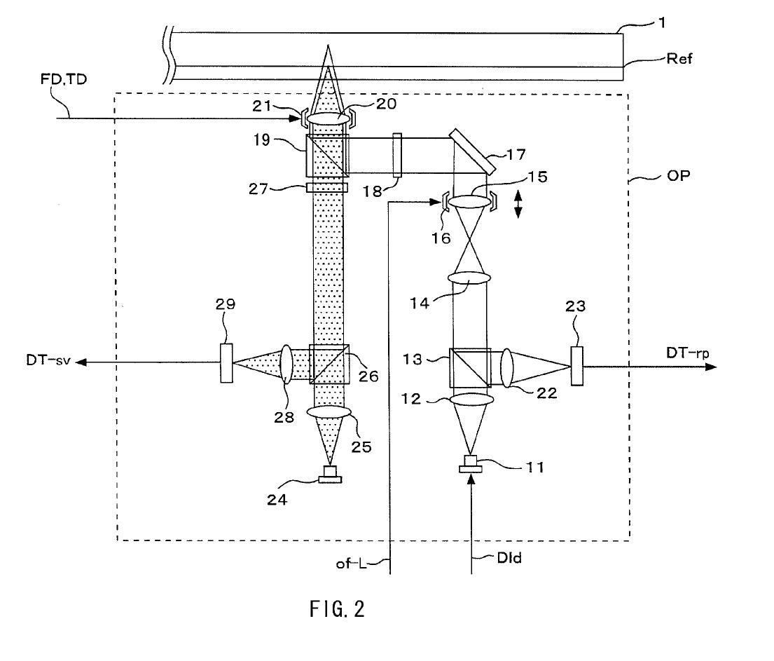

FIG. 2 mainly illustrates a configuration of an optical system in the reproducing apparatus as an embodiment (called recording/reproducing apparatus 10) performing recording/reproduction of the bulk-type recording medium 1 having the sectional structure as shown in FIG. 1. Specifically, FIG. 2 mainly illustrates an internal configuration of an optical pickup OP in the recording/reproducing apparatus 10.

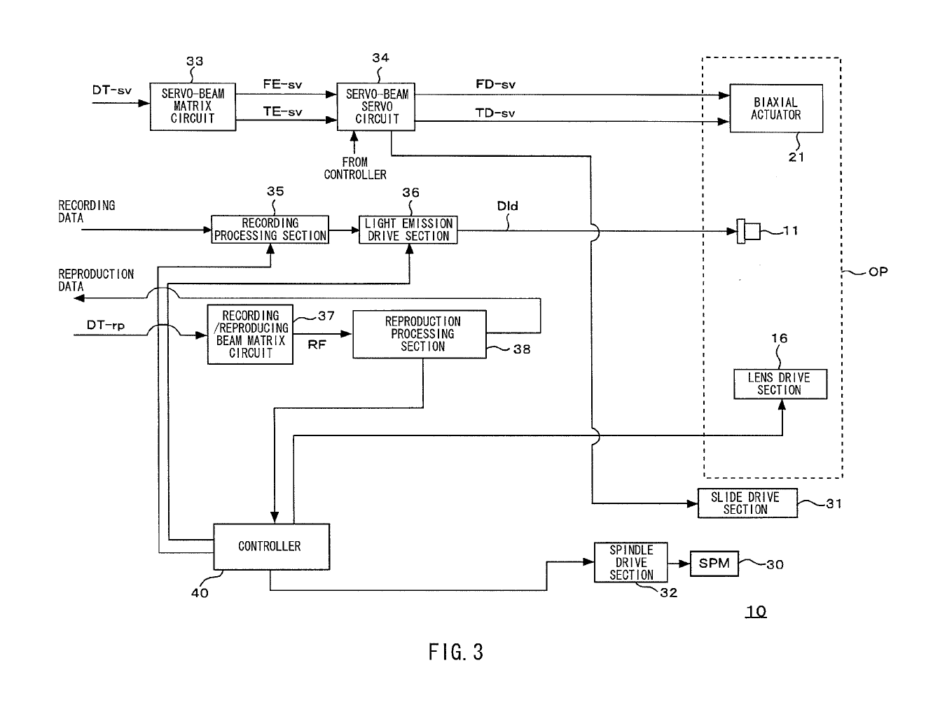

In FIG. 2, the bulk-type recording medium 1 loaded in the recording/reproducing apparatus 10 is set with a center hole thereof being clamped at a predetermined position in the recording/reproducing apparatus 10, and held in a state where the medium may be rotated by a not-shown spindle motor 30 (see FIG. 3). The optical pickup OP is provided to irradiate the bulk-type recording medium 1 to be rotated by the spindle motor 30 with the recording/reproducing laser beam and the servo laser beam.

The optical pickup OP internally includes a recording/reproducing laser 11 as a beam source of the recording/reproducing laser beam for information recording with marks and reproduction of the information recorded with the marks, and a servo laser 24 as a beam source of the servo laser beam as a beam for position control using the position guider formed on the reference surface Ref. The recording/reproducing laser beam and the servo laser beam are different in wavelength from each other as described before. In this example, the wavelength of the recording/reproducing laser beam is approximately 405 nm (so-called blue-violet laser beam), and the wavelength of the servo laser beam is approximately 650 nm (red laser beam).

Moreover, the optical pickup OP internally includes an objective lens 20 as an output end of each of the recording/reproducing laser beam and the servo laser beam to the bulk-type recording medium 1. The objective lens 20 has an effective numerical aperture NA of approximately 0.85 for the recording/reproducing laser beam, and approximately 0.65 for the servo laser beam.

The optical pickup OP internally includes a recording/reproducing beam receiving section 23 for receiving a reflected beam of the recording/reproducing laser beam from the bulk-type recording medium 1. In addition, the optical pickup OP is provided with an optical system for guiding the recording/reproducing laser beam emitted by the recording/reproducing laser 11 to the objective lens 20, and for guiding a reflected beam of the recording/reproducing laser beam from the bulk-type recording medium 1 to the recording/reproducing beam receiving section 23 through the objective lens 20.

In such an optical system for the recording/reproducing laser beam, the recording/reproducing laser beam emitted by the recording/reproducing laser 11 is formed into a parallel beam through a collimation lens 12, and then input to a polarizing beam splitter 13. The polarizing beam splitter 13 is configured to transmit such a recording/reproducing laser beam input from a recording/reproducing laser 11 side.

The recording/reproducing laser beam transmitted by the polarizing beam splitter 13 is input to an expander configured of a fixed lens 14, a movable lens 15, and a lens drive section 16. In the expander, the fixed lens 14 is disposed on a side near the recording/reproducing laser 11 as a beam source, the movable lens 15 is disposed on a side far from the recording/reproducing laser 11, and the movable lens 15 is moved by the lens drive section 16 in a direction parallel to an optical axis of the recording/reproducing laser beam, thereby a collimation state (for example, a state of convergence, parallelism, or radiation) of the recording/reproducing laser beam input to the objective lens 20 is changed. Consequently, the recording/reproducing laser beam is independently subjected to focus control (focus position control). In this sense, the expander including the fixed lens 14, the movable lens 15, and the lens drive section 16 may be called recording/reproducing beam focusing mechanism below.

As described later, the lens drive section 16 in the recording/reproducing beam focusing mechanism is moved by the controller 40 shown in FIG. 3 depending on a value of the offset of-L set in correspondence to an information recording layer position L as an object.

The recording/reproducing laser beam is input to the mirror 17 through the fixed lens 14 and the movable lens 15 forming the recording/reproducing beam focusing mechanism, and reflected by the mirror 17 as illustrated in FIG. 3, and then input to a dichroic prism 19 through a quarter-wavelength plate 18. The dichroic prism 19 includes a selective reflection surface that reflects a beam in the same wavelength range as the recording/reproducing laser beam, and transmits a beam having another wavelength. Consequently, the recording/reproducing laser beam input to the dichroic prism 19 in the above way is reflected by the dichroic prism 19.

The recording/reproducing laser beam reflected by the dichroic prism 19 is applied to the bulk-type recording medium 1 through the objective lens 20 as illustrated in FIG. 2. A biaxial actuator 21 is provided for the objective lens 20 to hold the objective lens 20 in a displaceable manner in a focusing direction (vertical direction to the bulk-type recording medium 1) and in a tracking direction (direction orthogonal to the focusing direction, namely, direction parallel to the radial direction of the bulk-type recording medium 1). Here, the biaxial actuator 21 has a focusing coil and a tracking coil, and drive signals (drive signals FD and TD described later) are applied to the respective coils, thereby the objective lens 20 is displaced in each of focusing and tracking directions.

In reproduction, a reflected beam of the recording/reproducing laser beam is provided from the bulk-type recording medium 1, or from a mark formed in an information recording layer L as a reproducing object in the bulk layer 5, in response to application of the recording/reproducing laser beam to the bulk-type recording medium 1 in the above way. The reflected beam of the recording/reproducing laser beam provided in this way is guided to the dichroic prism 19 through the objective lens 20, and reflected by the dichroic prism 19. After being reflected by the dichroic prism 19, the reflected beam of the recording/reproducing laser beam is input to the polarizing beam splitter 13 through the quarter-wavelength plate 18, the mirror 17, and the recording/reproducing beam focusing mechanism (the movable lens 15 and the fixed lens 14) in this order.

While the reflected beam (return beam) of the recording/reproducing laser beam is input to the polarizing beam splitter 13 in this way, the reflected beam is different in polarization direction by 90 degrees from the recording/reproducing laser beam (going beam) input to the polarizing beam splitter 13 from the recording/reproducing laser beam 11 side by operation of the quarter-wavelength plate 18 and operation of the bulk-type recording medium 1 during reflection. As a result, the reflected beam of the recording/reproducing laser beam input to the polarizing beam splitter 13 in the above way is reflected by the polarizing beam splitter 13.

After being reflected by the polarizing beam splitter 13 in the above way, the reflected beam of the recording/reproducing laser beam is condensed on a beam receiving surface of the recording/reproducing beam receiving section 23 through a condensing lens 22. The recording/reproducing beam receiving section 23 receives the reflected beam of the recording/reproducing laser beam condensed in this way, and thus outputs a beam receiving signal that is represented as a beam receiving signal DT-rp as shown in FIG. 2.

The optical pickup OP internally includes the configuration of the optical system for the recording/reproducing laser beam as described before, and further includes an optical system for guiding the servo laser beam emitted by the servo laser 24 to the objective lens 20, and for guiding the reflected beam of the servo laser beam from the bulk-type recording medium 1 to a servo beam receiving section 29 through the objective lens 20. As illustrated in FIG. 2, the servo laser beam emitted by the servo laser 24 is formed into a parallel beam through a collimation lens 25, and then input to a polarizing beam splitter 26. The polarizing beam splitter 26 is configured to transmit such a servo laser beam (going beam) input from a servo laser 24 side.

The servo laser beam transmitted by the polarizing beam splitter 26 is input to the dichroic prism 19 through a quarter-wavelength plate 27. Since the dichroic prism 19 reflects a beam in the same wavelength range as the recording/reproducing laser beam, and transmits a beam having another wavelength as described before, the servo laser beam is transmitted by the dichroic prism 19, and applied to the bulk-type recording medium 1 through the objective lens 20.

A reflected beam (reflected beam from the reference surface Ref) of the servo laser beam is provided in response to application of the servo laser beam to the bulk-type recording medium 1 in the above way. The reflected beam is input to the dichroic prism 19 through the objective lens 20 and transmitted by the dichroic prism 19, and then input to the polarizing beam splitter 26 through the quarter-wavelength plate 27. As in the case of the recording/reproducing laser beam, the reflected beam (return beam) of the servo laser beam input from the bulk-type recording medium 1 side in this way is different in polarization direction by 90 degrees from the going beam by operation of the quarter-wavelength plate 27 and operation of the bulk-type recording medium 1 during reflection. Consequently, the reflected beam of the servo laser beam as the return beam is reflected by the polarizing beam splitter 26.

After being reflected by the polarizing beam splitter 26, the reflected beam of the servo laser beam is condensed on a beam receiving surface of the servo beam receiving section 29 through a condensing lens 28. The servo beam receiving section 29 receives the reflected beam of the servo laser beam, and thus outputs a beam receiving signal that is represented as a beam receiving signal DT-sv.

FIG. 3 illustrates a general internal configuration of the recording/reproducing apparatus 10. FIG. 3 shows only the recording/reproducing laser 11, the lens drive section 16, and the biaxial actuator 21 among components of the internal configuration of the optical pickup OP shown in FIG. 2.

In FIG. 3, the recording/reproducing apparatus 10 includes a slide drive section 31 that slidably moves the optical pickup OP as a whole in the tracking direction. The slide operation by the slide drive section 31 is controlled based on a slide drive signal from a servo-beam servo circuit 34 described later.

In addition, the recording/reproducing apparatus 10 includes a spindle motor (SPM) 30 for rotating the bulk-type recording medium 1 as shown in FIG. 2. Drive of the spindle motor 30 is controlled based on a rotational drive signal from the spindle drive section 32 in FIG. 3. The spindle drive section 32 receives a rotation start/stop instruction and an acceleration/deceleration instruction from the controller 40, and starts or stops rotation of the spindle motor 30 and controls acceleration or deceleration of the spindle motor based on the instructions.

In addition, the recording/reproducing apparatus 10 includes a servo-beam matrix circuit 33 and the servo-beam servo circuit 34 as a signal processing system of the reflected beam of the servo laser beam.

The servo-beam matrix circuit 33 includes a current-to-voltage conversion circuit, a matrix operation/amplification circuit, and the like for beam receiving signals DT-sv (output currents) from a plurality of beam receiving elements as the servo-beam receiving section 29 shown in FIG. 2, and generates necessary signals through matrix operation processing. Specifically, the servo-beam matrix circuit 33 generates a tracking error signal TE-sv, which indicates the amount of shift (tracking error) in a radial direction of a irradiation spot of the servo laser beam with respect to a guide groove (truck) formed on the reference surface Ref, as a signal for tracking servo control. In addition, the servo-beam circuit 33 generates a focusing error signal FE-sv, which indicates a focusing error of the servo laser beam with respect to the reference surface Ref (selective reflection film 3), as a signal for focusing servo control. In addition, the servo-beam matrix circuit 33 generates a not-shown positional information detecting signal for detecting positional information such as radial position information or rotational angle information recorded on the reference surface Ref. For example, when positional information is recorded with a pit string, the servo-beam matrix circuit 33 generates a sum signal as the positional information detecting signal. Alternatively, when positional information is recorded with a wobbling group, the servo-beam matrix circuit 33 generates a push-pull signal.

The focusing error signal FE-sv and the tracking error signal TE-sv generated by the servo-beam matrix circuit 33 are supplied to the servo-beam servo circuit 34. The servo-beam servo circuit 34 generates a focusing servo signal FS-sv and a tracking servo signal TS-sv based on the focusing error signal FE-sv and the tracking error signal TE-sv, respectively. In addition, the servo-beam servo circuit 34 generates a focusing drive signal FD-sv and a tracking drive signal TD-sv based on the focusing servo signal FS-sv and the tracking servo signal TS-sv, and drives the focusing coil and the tracking coil of the biaxial actuator 21 based on the focusing drive signal FD-sv and tracking drive signal TD-sv according to instructions from the controller 40, so that focusing servo control and tracking servo control for the objective lens 20 are achieved.

In addition, the servo-beam servo circuit 34 turns off a tracking servo loop to apply a jump pulse to the tracking coil of the biaxial actuator 21 so as to achieve track jump operation, or performs pull-in control of tracking servo, and the like according to instructions from the controller 40. In addition, the servo-beam servo circuit 34 performs pull-in control of focusing servo with respect to the reference surface Ref and the like.

In addition, the servo-beam servo circuit 34 extracts a low level component of the tracking error signal TE-sv to generate a slide error signal, and generates the slide drive signal based on the slide error signal, and controls drive operation of the slide drive section 31 based on the slide drive signal. Consequently, so-called slide servo (sled servo) control is achieved. In seek, the servo-beam servo circuit 34 controls the slide drive section 31 such that the optical pickup OP is moved to a position corresponding to a target address instructed by the controller 40.

Moreover, the recording/reproducing apparatus 10 includes the configuration including a recording processing section 35, a light emission drive section 36, a recording/reproducing beam matrix circuit 37, and a reproduction processing section 38 as shown in FIG. 3 as a configuration for recording/reproduction of the bulk layer 5.

The recording processing section 35 receives data (recording data) to be recorded to the bulk-type recording medium 1. The recording processing section 35 adds an error correction code or performs predetermined recording modulation coding to the input data to acquire a recording modulation data string that is actually recorded in the bulk-type recording medium 1, for example, a binary data string of “0” and “1”. The recording processing section 35 generates a recording signal based on such a recording modulation data string, and outputs the recording signal to the light emission drive section 36.

In recording, the light emission drive section 36 generates a drive signal Dld based on the recording signal received from the recording processing section 35, and drives light emission of the recording/reproducing laser 11 in the optical pickup OP based on the drive signal Dld. In reproduction, the light emission drive section 36 outputs a drive signal Dld to the recording/reproducing laser 11 so that the recording/reproducing laser 11 emits light by reproducing power, in response to an instruction from the controller 40.

The recording/reproducing beam matrix circuit 37 includes a current-to-voltage conversion circuit, a matrix operation/amplification circuit, and the like for beam receiving signals DT-rp (output currents) from a plurality of beam receiving elements as the recording/reproducing beam receiving section 23 shown in FIG. 2, and generates necessary signals through matrix operation processing. Specifically, the recording/reproducing beam matrix circuit 37 generates a high frequency signal (hereinafter, called reproduction signal RF) corresponding to a reproduction signal as a reproduction of the recording modulation data string.

The reproduction signal RF generated by the recording/reproducing beam matrix circuit 37 is supplied to the reproduction processing section 38.

The reproduction processing section 38 performs reproduction processing of the reproduction signal RF, such as binarization processing or decoding/error correction processing of the recording modulation code, for restoring the recording data, and thus acquires reproduction data as a reproduction of the recording data.

The controller 40 is configured of, for example, a microcomputer having CPU (Central Processing Unit) and a memory (storage device) such as ROM (Read Only Memory) and RAM (Random Access Memory), and, for example, performs control/processing in accordance with a program stored in the ROM or the like to perform overall control of the recording/reproducing apparatus 10. For example, the controller 40 performs setting control of a focus position of the recording/reproducing laser beam based on a value of offset of-L that is beforehand set in correspondence to each layer position in the bulk layer 5 as described before. Specifically, the controller 40 drives the lens drive section 16 in the optical pickup OP based on a value of offset of-L set in correspondence to each of the information recording layer positions L as a recording or reproducing object, and thus selects a recording/reproducing position in the depth direction.

Moreover, the controller 40 instructs the servo-beam servo circuit 34 to seek a target address. That is, the controller 40 indicates a target address as a recording/reproducing start position to the servo-beam servo circuit 34 so that a irradiation spot of the servo laser beam is moved to the target address on the reference surface Ref. Accordingly, a spot position, or a position in the tracking direction, of the recording/reproducing laser beam is also moved to a position corresponding to the target address.

### [3. Focus Control Technique in Reproduction]

As described before, when recording/reproduction of the bulk-type optical recording medium is performed, focus control (focus position adjustment) of the recording/reproducing laser beam in reproduction has been performed using the same technique as in recording. Specifically, while a position of the objective lens 20 in the focus direction is controlled such that a focus position of the servo laser beam corresponds to the reference surface Ref, the recording/reproducing beam focusing mechanism (lens drive section 16) is moved based on the value of the offset of-L set in correspondence to each of information recording layer positions L as a reproducing object.

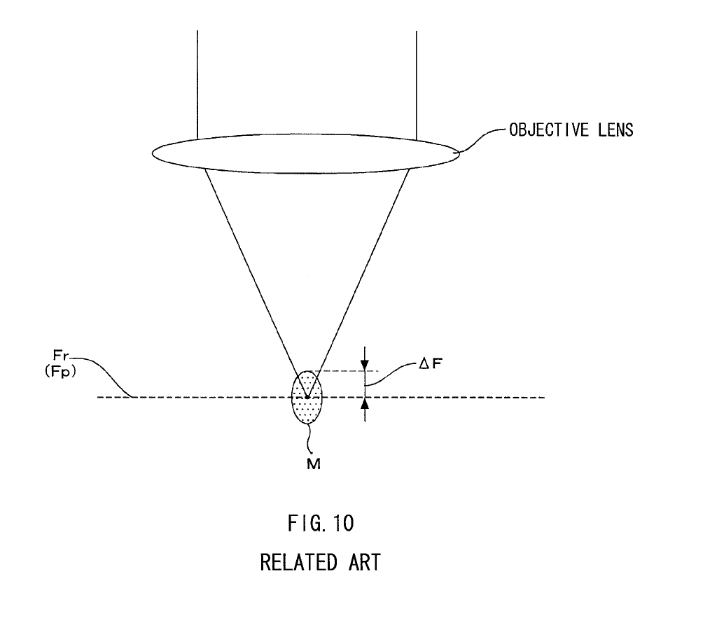

However, focus control of the recording/reproducing laser beam is performed using the same technique in each of recording and reproducing in this way, causing defocus ΔF of the recording/reproducing laser beam to a void mark M formed at the information recording layer position L as the reproducing object, which disadvantageously causes reduction in SNR (Signal-to-Noise Ratio) of a reproduction signal, as described with reference to FIG. 10.

To confirm, in the void recording method, voids are formed, causing a difference in refractive index between each void and other portions, and a boundary of the void is thus allowed to function as a reflective surface to a reproducing beam by the difference in refractive index, enabling information recording. The light quantity of a reflected beam from the void mark M may be therefore reduced due to defocus AF from an upper boundary of the void mark M as shown in FIG. 10, causing reduction in SNR of the reproduction signal.

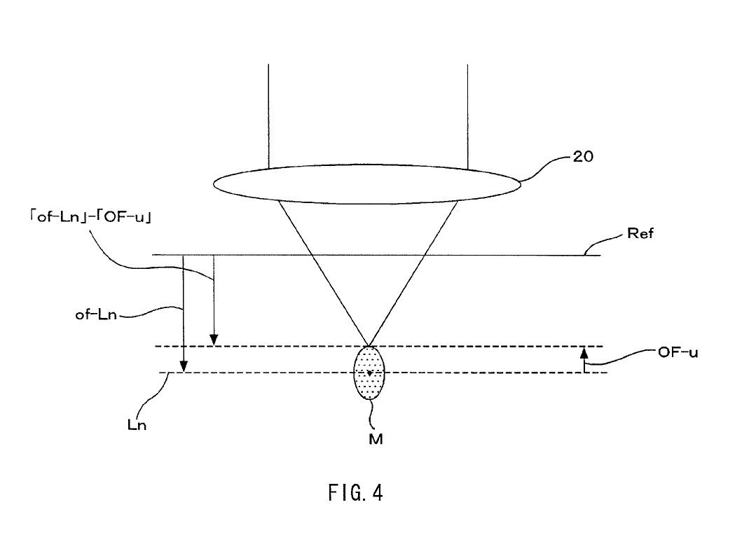

Thus, the embodiment proposes a technique to improve SNR by suppressing the defocus ΔF. FIG. 4 illustrates a focus control technique in reproduction of the embodiment. It is to be noted that, in FIG. 4, “Ln” means an information recording layer position L as a reproducing object, and “of-Ln” means an offset value of-L set in correspondence to the information recording layer position Ln as a reproducing object.

As illustrated in FIG. 4, in the embodiment, a focus position of the recording/reproducing laser beam in reproduction is controlled to a position shifted to an upper layer side by a certain distance as the offset OF-u in the figure from the information recording layer position Ln as a reproducing object. This makes it possible to increase the light quantity of a reflected beam compared with a case where a focus position corresponds to the center of the mark M as in the past, leading to improvement in SNR of the reproduction signal.

Here, the offset OF-u is preferably set such that the focus position corresponds to the upper boundary of the void mark M depending on size of the void mark M which is actually formed. This is because when the focus position corresponds to the upper boundary of the mark M, the amount of defocus may be minimized, and consequently the light quantity of the reflected beam may be maximized.

In addition, the offset OF-u may be set such that the focus position is located on the upper layer side of the upper boundary of the void mark M. However, if the focus position is much away from the upper boundary of the void mark M to the upper layer side, the light quantity of the reflected beam is rather reduced. Thus, when the focus position is shifted to the upper layer side from the upper boundary of the mark M, the offset OF-u is set to satisfy OF-u<2*defocus ΔF. This makes it possible to reduce the amount of defocus from the upper boundary of the void mark M compared with in the past, and therefore an improvement effect of SNR may be expected.

In the recording/reproducing apparatus 10 of the embodiment, the controller 40 controls the above shift of the focus position to the upper layer side in reproduction. Specifically, the controller 40 drives the lens drive section 16 based on a value (corresponding to “of-L”-“OF-u” in FIG. 4) of subtracting a value of offset OF-u being beforehand set from a value of the offset of-L set in correspondence to the information recording layer position Ln as a reproducing object. This makes it possible to control the focus position of the recording/reproducing laser beam in reproduction to correspond to a position shifted by a certain distance to an upper layer side from the information recording layer position Ln as a reproducing object.

Here, when the value of the offset OF-u is set such that the amount of defocus of the recording/reproducing laser beam from the upper boundary of the void mark M is smaller than defocus ΔF in the past (that is, smaller than a distance from the center of the void mark M to the upper boundary thereof) based on, for example, a result of an advance measurement of size of the void mark M, the improvement effect of SNR may be attained. Furthermore, when the value of the offset OF-u is set such that the amount of the defocus is zero (the focus position corresponds to the upper boundary of the void mark M), the improvement effect of SNR may be maximized.

As described above, according to the embodiment, defocus of the recording/reproducing laser beam may be suppressed in reproduction, and therefore SNR of the reproduction signal may be improved compared with the technique in the past. Accordingly, measures to improve SNR, such as increase in reproducing power of a recording/reproducing laser beam or choice of a sensitive article as the recording/reproducing beam receiving section 23, need not be taken, resulting in reduction in damage to a recording material for the bulk layer 5, reduction in power consumption of a system, long laser life, improvement in transfer rate, and reduction in development/production cost.

In addition, since SNR is improved, recording density in the bulk layer 5 may be increased, leading to large recording capacity of the bulk-type recording medium 1. Moreover, since damage to the recording material is reduced, preservation stability of recorded information may be improved. Moreover, the SNR improvement technique in the embodiment is extremely simple: the focus position is shifted by a certain distance. In this respect, the technique contributes to simplification of algorithmic development and of IC development.

### [4. Experimental Result]

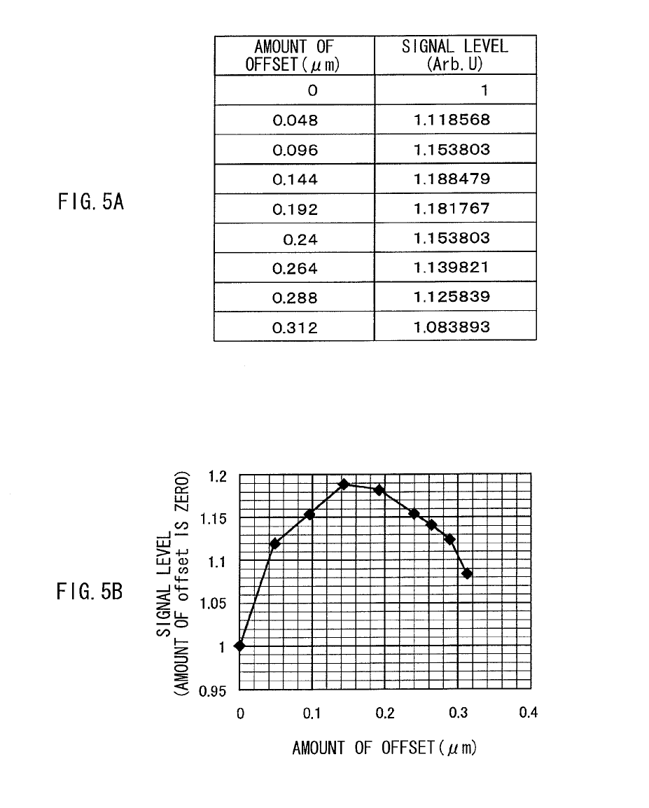

FIGS. 5A and 5B illustrate an experimental result of a relationship between the amount of offset from the focus position in recording and a signal level. Specifically, FIG. 5A is a table showing an experimental result of a relationship between the amount of offset (offset OF-u) of the recording/reproducing laser beam from the focus position in recording to the focus position in reproduction and a level of the reproduction signal, and FIG. 5B is a graph showing the experimental result. In FIGS. 5A and 5B, the reproduction signal level is shown by a relative value assuming that the signal level is 1 when the amount of offset is 0. To have the experimental result shown in the figures, the focus position of the recording/reproducing laser beam in recording was set to a position 100 μm deep from a surface (top surface) of the bulk-type recording medium 1. In addition, a monotone pattern with a signal period of 930 nm was used as a recording pattern.

As known from the experimental result, the signal level gradually increases as the amount of offset is gradually increased from zero, and reaches a peak at a certain amount of offset, and then gradually decreases with increase in amount of offset. This result demonstrates the described relationship between the amount of defocus and SNR. Specifically, when the amount of defocus of the recording/reproducing laser beam from the upper boundary of the void mark M is reduced, SNR is improved.

In the experiment, size (diameter) of the void mark M is approximately 300 nm. The experimental result shown in FIGS. 5A and 5B reveals that the signal level is maximized at the amount of offset of 0.144 nm. This suggests that when the amount of offset is adjusted to correspond to “the distance from the center of the void mark M to the upper boundary thereof”, the signal level is maximized. Consequently, when the focus position of the recording/reproducing laser beam is adjusted to correspond to the upper boundary of the void mark M (that is, when the amount of defocus is zero), the improvement effect of SNR is maximized. It is to be noted that when the amount of offset was adjusted to be 0.144 μm, the error rate was extremely low, 10⁻⁴.

### [5. Modifications]

While the embodiment of the disclosure has been described hereinbefore, the disclosure is not limited to the specific example as described above. For example, while description has been made exemplifying a technique of changing a drive level of the lens drive section 16 from a previous level as a technique to shift the focus position of the recording/reproducing laser beam in reproduction from the focus position thereof in recording, shift of the focus position of the recording/reproducing laser beam may be achieved by inputting a predetermined offset to a focus servo loop formed through focus servo control of the servo-beam servo circuit 34. That is, offset based on a value corresponding to the offset OF-u is satisfactorily input to the focus servo loop. It is to be noted that such offset is preferably input to an adder after the adder is provided in the focus servo loop. The controller 40 may directly input a value of the offset to the adder.

In addition, while description has been made exemplifying a case where a laser beam for recording and a laser beam for reproduction are emitted from a common light source, light sources of the respective laser beams may be separately provided. In particular, in the case of the void recording method, relatively high power is expected to be necessary for mark formation. In such a case, a short pulse laser (for example, picosecond pulse oscillation laser) for recording and a CW (Continuous Wave) laser for reproduction may be separately provided.

In addition, while description has been made exemplifying a case where the reference surface Ref on the bulk-type optical recording medium is provided on an upper layer side of the bulk layer 5, the reference surface Ref may be provided on a lower layer side of the bulk layer 5. Even in such a case, adjustment of the focus position of the recording/reproducing laser beam with respect to each information recording layer position L may be achieved, for example, in the following manner: offset of-L is determined for each of the information recording layer positions L with a predetermined depth position such as the reference surface Ref as a reference, and then the recording/reproducing beam focusing mechanism is moved in accordance with the offset of-L. When the reference surface Ref is provided on the lower layer side of the bulk layer 5, the reflection film to be formed on the reference surface Ref (reflection film for the servo laser beam) is advantageously not necessary to have the wavelength selectivity of reflecting the servo laser beam but transmitting the recording/reproducing laser beam.

In addition, while description has been made exemplifying a structure where the intermediate layer 4 is provided between the bulk layer 5 and the selective reflection film 3, the intermediate layer 4 may not be provided. For example, when a recording material of the bulk layer 5 is a thermosetting or photocurable resin, the resin material is applied on a bottom surface side of the selective reflection film 3 and then cured, thereby the bulk layer 5 may be formed on the bottom surface side of the selective reflection film 3 without forming the intermediate layer 104. Alternatively, when the bulk layer 5 is formed of resin, an irregular structure, or pits or a groove, is formed on a top surface side of the bulk layer 5, for example, by injection molding using a stamper, and a reflection film to be the reference surface Ref is formed thereon, and a cover layer 101 is formed on an upper layer side of the reflection film, thereby the structure without the intermediate layer 4 may be achieved. In addition, it will be appreciated that when the reference surface Ref is provided on the lower layer side of the bulk layer 5, the structure without the intermediate layer 4 may be similarly formed.

The present disclosure contains subject matter related to that disclosed in Japanese Priority Patent Application JP 2010-273796 filed in the Japan Patent Office on Dec. 8, 2010, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A reproducing apparatus comprising:
a first laser irradiation section irradiating an optical recording medium having a bulk recording layer with a first laser beam through an objective lens, the optical recording medium having recording marks formed by focusing a laser beam on each predetermined layer position in the recording layer;
a focus position adjusting section adjusting a focus position of the first laser beam;
a beam receiving section receiving a reflected beam of the first laser beam from each of the marks formed in the optical recording medium and generating a light receiving signal;
a reproducing section reproducing information recorded with each of the marks based on the light receiving signal generated by the beam receiving section; and
a control section performing control to allow the focus position of the first laser beam in reproduction of the information recorded with each of the marks to correspond to a position shifted by a certain distance to an upper layer side from a focus position of the laser beam in forming the mark at each of the layer positions as a reproducing object.

2. The reproducing apparatus according to claim 1, further comprising:
a second laser irradiation section irradiating the optical recording medium with a second laser beam different from the first laser beam through the objective lens,
the optical recording medium having a reference surface reflecting the second laser beam at a position different from a position of the recording layer;
a focusing mechanism of the objective lens; and
a focus servo control section performing focus servo control for the objective lens based on a result of receiving a reflected beam of the second laser beam from the reference surface,
wherein the focus position adjusting section is configured to change a collimation state of the first laser beam input to the objective lens to allow the focus position of the first laser beam to be adjusted.

3. The reproducing apparatus according to claim 2, wherein the control section controls the focus position adjusting section to shift the focus position of the first laser beam by a certain distance to the upper layer side.

4. The reproducing apparatus according to claim 2, wherein the control section inputs a certain offset value to a focus servo loop formed along with the focus servo control performed by the focus servo control section, and thus controls the focus position adjusting section to shift the focus position of the first laser beam by a certain distance to the upper layer side.

5. A reproducing method, comprising
reproducing an optical recording medium having a bulk recording layer, the optical recording medium having recording marks by a laser beam focused on each predetermined layer position in the recording layer, wherein,
in reproducing the optical recording medium, information recorded with each of the marks is reproduced in a state that a focus position of a first laser beam applied for reproducing the information recorded with each of the marks is shifted by a certain distance from a focus position of the laser beam in forming the mark at each of the layer positions as a reproducing object.

6. A reproducing apparatus comprising:
a first laser irradiation section irradiating an optical recording medium having a bulk recording layer with a first laser beam through an objective lens, the optical recording medium having recording marks formed by focusing a laser beam on each predetermined layer position in the recording layer;
a focus position adjusting section adjusting a focus position of the first laser beam;
a beam receiving section receiving a reflected beam of the first laser beam from each of the marks formed in the optical recording medium, and generating a light receiving signal;
a reproducing section reproducing information recorded with each of the marks based on the light receiving signal generated by the beam receiving section; and
a control section controlling the focus position adjusting section to allow the focus position of the first laser beam in reproduction of the information recorded with each of the marks to correspond to a top surface portion of the mark formed at each of the layer positions as a reproducing object.
